(19) United States
(12) Patent Application Publication
(10) Pub. No.: US 2015/0278143 A1
(43) Pub. Date: Oct. 1, 2015

(54) Method And Device For Connecting USB Port And Method For Transmitting Data

(71) Applicant: HISENSE BROADBAND MULTIMEDIA TECHNOLOGIES CO., LTD., Qingdao (CN)

(72) Inventors: Chaoqun YU, Qingdao (CN); Peishu LI, Qingdao (CN); Xiuyu LI, Qingdao (CN)

(21) Appl. No.: 14/671,165

(22) Filed: Mar. 27, 2015

(30) Foreign Application Priority Data
Mar. 27, 2014 (CN) 201410119869.8

(51) Int. Cl. G06F 13/40; G06F 13/12

(52) U.S. Cl. CPC G06F 13/4022; G06F 13/122

(57) ABSTRACT

The disclosure discloses a method and device for connecting a USB port, and a method for transmitting data, and the method for connecting a USB port includes: checking, by a display device, for an internal module for which a USB needs to be accessed; and if the internal module for which the USB needs to be accessed is a TV set module, then connecting internal USB ports of the TV set module with external USB ports of the display device, and if the internal module for which the USB needs to be accessed is a set-top box module, then connecting internal USB ports of the set-top box module with the external USB ports of the display device.

### CROSS-REFERENCE TO RELATED APPLICATION

This application claims the benefit and priority of Chinese Patent Application No. 201410119869.8 filed Mar. 27, 2014. The entire disclosure of the above application is incorporated herein by reference.

### FIELD

The present disclosure relates to the field of multimedia technologies and particularly to a method and device for connecting a USB port and a method for transmitting data.

### BACKGROUND

This section provides background information related to the present disclosure which is not necessarily prior art.

FIG. 1 illustrates a set-top box being connected with a Universal Serial Bus (USB) of a TV set in the prior art. In FIG. 1, USB ports of the set-top box module 1 are separate from USB ports of the TV set chip, and both the set-top box module 1 and the TV set chip are provided with four USB ports, where the four USB ports 1 to 4 of the set-top box 1 are connected with the four USB ports 1 to 4 of the TV set master board through a set of connectors; and the four USB ports 5 to 8 of the TV set chip are connected with the USB ports 5 to 8 of the TV set master board. An audio-video output of the set-top box 1 is connected with an input channel of the TV set, e.g., a High Definition Multimedia Interface (HDMI) channel.

It may be difficult for a non-professional general user to distinguish the USB ports 1 to 4 and the USB ports 5 to 8 of the TV set even if they are indicated proximate thereto to correspond to the set-top box and the TV set respectively.

If the TV set supports a plurality of set-top box modules, and the USB ports of the respective set-top box modules are separate from each other, then there may be more than 10 external USB ports on the TV set.

### SUMMARY

This section provides a general summary of the disclosure, and is not a comprehensive disclosure of its full scope or all of its features.

In an aspect, some embodiments of the disclosure provide a method for connecting a USB port, the method including:

checking, by a display device, for an internal module for which a USB needs to be accessed; and

if the internal module for which the USB needs to be accessed is a TV set module, then connecting internal USB ports of the TV set module with external USB ports of the display device, and

if the internal module for which the USB needs to be accessed is a set-top box module, then connecting internal USB ports of the set-top box module with the external USB ports of the display device;

wherein the external USB ports connected with the internal USB ports of the TV set module are the same as a part or all of the external USB ports connected with the internal USB ports of the set-top box module.

In another aspect, some embodiments of the disclosure further provide a display device for connecting a USB port, including a TV set module and a set-top box module, the device further including:

a control chip configured to check for an internal module for which a USB needs to be accessed, after the display device is powered on; and if the internal module for which the USB needs to be accessed is a TV set module, to connect internal USB ports of the TV set module with external USB ports of the display device; and if the internal module for which the USB needs to be accessed is a set-top box module, to connect internal USB ports of the set-top box module with the external USB ports of the display device;

wherein the external USB ports connected with the internal USB ports of the TV set module are the same as a part or all of the external USB ports connected with the internal USB ports of the set-top box module.

In a further aspect, some embodiments of the disclosure further provide a method for transmitting data, the method being applicable to a display component including a display device and a plurality of function modules, wherein each of the plurality of the function modules is connected with the display device via a data transmission interface, and the display device includes a data transmission port for connection with an external device, and the method includes:

determining a function module for which data needs to be transmitted with the external device;

enabling, by a switch selection element, the data transmission interface via which the function module for which data needs to be transmitted and the display device are connected;

setting up a connection pathway between the function module for which data needs to be transmitted, and a data transmission port of the display device; and

transmitting data over the set-up connection pathway.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates a set-top box being connected with a USB of a TV set in the prior art;

FIG. 2 illustrates a flow chart of a method for connecting a USB port according to an embodiment of the disclosure;

FIG. 3 illustrates a flow chart of a power-on process of a TV set according to an embodiment of the disclosure;

FIG. 4 illustrates a schematic diagram of a device for connecting a USB port according to an embodiment of the disclosure;

FIG. 5A illustrates a schematic diagram of a device for connecting a USB port according to an embodiment of the disclosure;

FIG. 5B illustrates a flow chart of a device according to an embodiment of the disclosure;

FIG. 6A illustrates a schematic diagram of a device for connecting a USB port according to an embodiment of the disclosure; and

FIG. 6B illustrates a flow chart of a device according to an embodiment of the disclosure.

Corresponding reference numerals indicate corresponding parts throughout the several views of the drawings.

### DETAILED DESCRIPTION OF THE EMBODIMENTS

Example embodiments will now be described more fully with reference to the accompanying drawings.

According to some embodiments of the disclosure, a display device judges from a current display channel whether to connect an internal USB port of a TV set module or a set-top box module with an external USB port of the display device, where a part or all of external USB ports connected with internal USB ports of the TV set module are the same as external USB ports connected with internal USB ports of the set-top box module. The USB interfaces are common to the TV set module and the set-top box module in the embodiments of the disclosure to thereby lower the number of USB ports of the display device.

Where the set-top box module and the TV set module according to the embodiments of the disclosure can be integrated in one device, e.g., a combined TV set.

The number of set-top box modules can be one or more, including various set-top box modules connected in a wired manner or wirelessly with a radio and TV network, a local area network and a wide area network, and also various modules with game, entertainment, security and other dedicated functions.

The TV set module refers to an internal module unit with internal USB ports to support TV displaying. Preferred embodiments of the disclosure will be described below with reference to the drawings, and it shall be noted that the preferred embodiments described here are merely intended to illustrate and describe the disclosure but not intended to limit the disclosure. The embodiments of the disclosure and features thereof can be combined with each other unless they conflict.

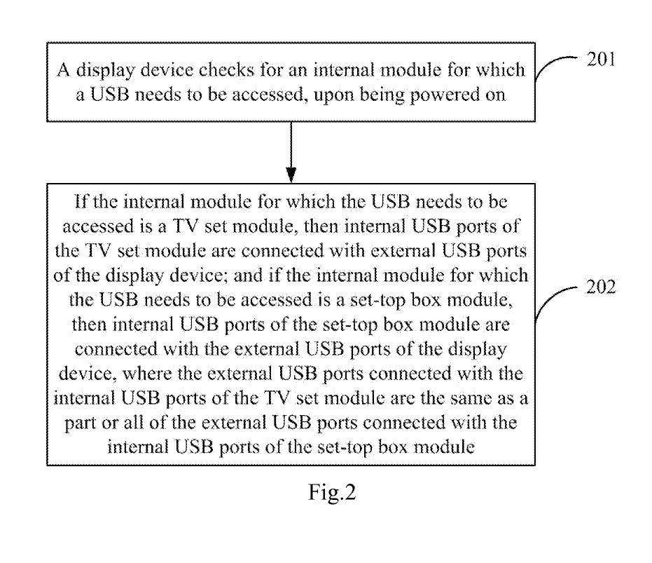

As illustrated in FIG. 2, a method for connecting a USB port according to an embodiment of the disclosure includes the followings operations:

In the operation 201, a display device checks for an internal module for which a USB needs to be accessed, upon being powered on; and

In the operation 202, if the internal module for which the USB needs to be accessed is a TV set module, then internal USB ports of the TV set module are connected with external USB ports of the display device; and if the internal module for which the USB needs to be accessed is a set-top box module, then internal USB ports of the set-top box module are connected with the external USB ports of the display device;

Where the external USB ports connected with the internal USB ports of the TV set module are the same as a part or all of the external USB ports connected with the internal USB ports of the set-top box module.

In the operation 201, the display device can check for an internal module for which the USB needs to be accessed, upon being powered on; or can check for an internal module for which the USB needs to be accessed, when a display channel is switched.

After the display device is powered on, master program of the display device is started to perform necessary initialization and other operations and then check for an internal module for which the USB needs to be accessed, dependent upon a currently connected display channel of the display device;

For example, the currently connected display channel can be a general TV channel (over which an analog signal is received), a wired TV channel (over which a digital signal is received), an IPTV network channel, an all-game function channel, a DVD player channel, etc.

In the operation 202, upon judging that the currently connected display channel is a TV channel (which is a general TV channel (over which an analog signal is received)), the display device determines that the internal module for which the USB needs to be accessed is the TV set module, and connects the internal USB ports of the TV set module with the external USB ports of the display device.

In an implementation, the internal USB ports of the TV set module can be connected with the external USB ports of the display device in a number of ways, for example:

The display device transmits a logic signal command to a USB change-over switch through a logic switch control unit to have the USB change-over switch switched onto the internal USB ports of the TV set module; and the display device connects the internal USB ports of the TV set module with the external USB ports of the display device, where the internal USB ports of the TV set module can be connected with a part or all of the external USB ports.

In the operation 202, upon judging that the currently connected display channel is not a TV channel or is some other channel, e.g., an HDMI, chromatic component, video or another channel, the display device determines that the internal module for which the USB needs to be accessed is the set-top box module, and connects the internal USB ports of the set-top box module with the external USB ports of the display device.

In an implementation, the internal USB ports of the set-top box module can be connected with the external USB ports of the display device in a number of ways, for example:

The display device transmits a logic signal command to the change-over switch through the logic switch control unit to have the change-over switch switched onto the internal USB ports of the set-top box module; and the display device connects the internal USB ports of the set-top box module with the external USB ports of the display device, where the internal USB ports of the set-top box module can be connected with a part or all of the external USB ports.

In an implementation, if there are a plurality of external USB ports, then the display device connects the internal USB ports of the TV set module with a part or all of the plurality of external USB ports, for example:

Suppose there is a peripheral device, e.g., a U-disk in which a video file is stored, inserted into one of the external USB ports of the display device; and

If one of the USB ports of the TV set module is connected with the external USB port, then the display device can identify a connected external device and perform relevant operations to switch synchronously the currently connected display channel of the display device onto a channel of the external USB port to thereby play the video file of the U-disk; and if there is no USB port of the TV set module connected with the external USB port, then there is no information about the inserted U-disk displayed on the current display channel of the display device.

Suppose there are a plurality of external USB ports of the display device, into each of which a peripheral device is inserted, and the inserted peripheral devices are a U-disk 1 in which a video file is stored, a U-disk 2 in which a document is stored, a U-disk 3 in which a picture file is stored, etc., respectively; and

If the USB ports of the TV set module are connected with all of the plurality of external USB ports, then the display device can identify a connected external device and perform relevant operations to select the video file or the document or the picture file for watching; and the currently connected display channel of the display device may be switched synchronously onto a channel of one of the external USB ports of the display device to thereby play one of the video file of the U-disk 1, the document of the U-disk 2 and the picture file of the U-disk 3.

If one of the USB ports of the TV set module is connected with only one of the plurality of external USB ports, then the display device identifies some connected device and performs relevant operations to select some file of the connected device for watching; and the currently connected display channel of the display device may be switched synchronously onto a channel of the external USB port of the display device to thereby play the file of some connected U-disk. If there is no USB port of the TV set module connected with the plurality of external USB ports, then there is no information about the inserted plurality of U-disk displayed on the current display channel of the display device.

In an implementation, if there are a plurality of external USB ports, then the display device connects the internal USB ports of the set-top box module with a part or all of the plurality of external USB ports, for example:

Suppose there is a peripheral device, e.g., a U-disk in which a video file is stored, inserted into one of the external USB ports of the display device; and

If one of the USB ports of the set-top box module is connected with the external USB port, then the display device can identify a connected external device and perform relevant operations to switch synchronously the currently connected display channel of the display device onto a channel of the external USB port to thereby play the video file of the U-disk; and if there is no USB port of the set-top box module connected with the external USB port, then there is no information about the inserted U-disk displayed on the current display channel of the display device.

Suppose there are a plurality of external USB ports of the display device, into each of which a peripheral device is inserted, and the inserted peripheral devices are a U-disk 1 in which a video file is stored, a U-disk 2 in which a document is stored, a U-disk 3 in which a picture file is stored, etc., respectively; and

If the USB ports of the set-top box module are connected with all of the plurality of external USB ports, then the display device can identify a connected external device and perform relevant operations to select the video file or the document or the picture file for watching; and the currently connected display channel of the display device may be switched synchronously onto a channel of one of the external USB ports of the display device to thereby play one of the video file of the U-disk 1, the document of the U-disk 2 and the picture file of the U-disk 3.

If one of the USB ports of the set-top box module is connected with only one of the plurality of external USB ports, then the display device identifies some connected device and performs relevant operations to select some file of the connected device for watching; and the currently connected display channel of the display device may be switched synchronously onto a channel of the external USB port of the display device to thereby play the file of some connected U-disk. If there is no USB port of the set-top box module connected with the plurality of external USB ports, then there is no information about the inserted plurality of U-disk displayed on the current display channel of the display device.

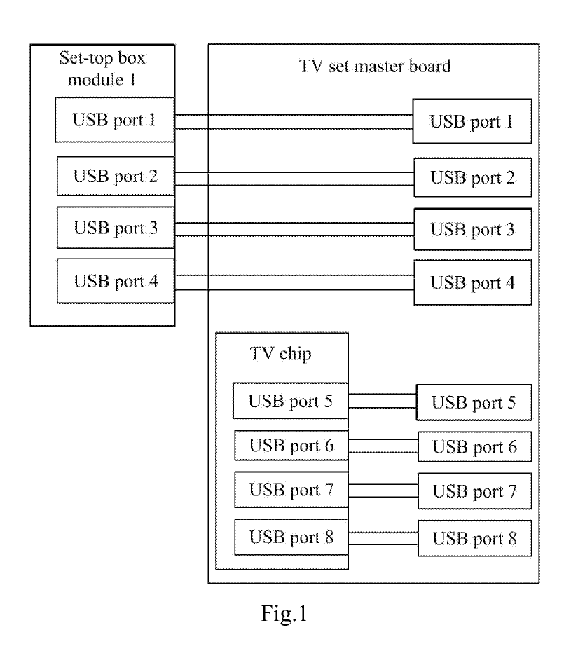

In the prior art, if the currently connected display channel of the TV set is the TV channel, then as illustrated in FIG. 1, when there is a USB peripheral device inserted into one of the four USB ports 5 to 8, of the TV set master board, connected with the USB ports 5 to 8 of the TV set chip, the TV set software program can identify the state and perform a relevant process; but if there is a USB peripheral device inserted into one of the USB ports 1 to 4 of the TV set master board when the display channel is the TV channel, then the TV set software program can not perform any relevant process and there may be no relevant display information.

If the currently connected display channel of the TV set is a channel of the set-top box module 1, then as illustrated in FIG. 1, when there is a USB peripheral device inserted into one of the USB ports 1 to 4 of the TV set master board, the TV set software program can identify the state and perform a relevant process; but if there is a USB peripheral device inserted into one of the four USB ports 5 to 8, of the TV set master board, connected with the USB ports 5 to 8 of the TV set chip, then the TV set software program can not perform any relevant process and there may be no relevant display information.

According to the embodiment of the disclosure, when the internal USB ports of the set-top box module are connected with all of the external USB ports, all of the external USB ports can be identified and a relevant process can be performed, so that the external device inserted into whichever of the USB ports can be accessed to thereby avoid such a situation in the prior art from occurring that only the external device inserted into the USB port corresponding to the display channel can be accessed.

As can be apparent from the description above, the external USB ports of the TV set can be connected with either the internal USB ports of the TV set module or the internal USB ports of the set-top box module to thereby lower the number of external USB ports of the TV set and save a space of the master board of the TV set.

The display device according to the embodiment of the disclosure can include but will not be limited to a TV set.

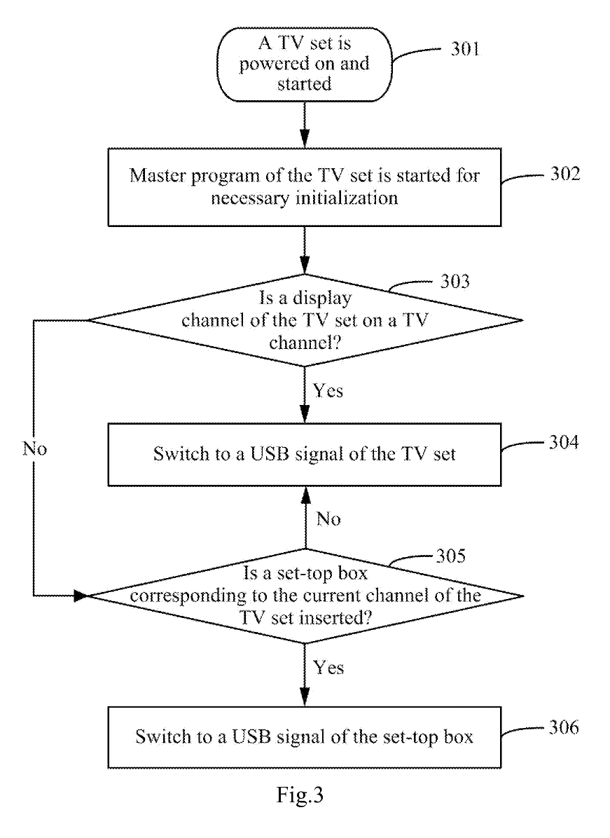

For better understanding of the technical solution according to the disclosure, a method for connecting a USB port according to the disclosure will be described below in details with reference to FIG. 3 taking a power-on flow of a TV set as an example.

In the operation 301, a TV set is powered on and started.

In the operation 301, the TV set is powered up by a master board of the TV set or by a remote control board.

In the operation 302, master program of the TV set is started for initialization.

In the operation 303, a control chip judges whether a currently connected display channel of the TV set is on a TV channel; and if so, then the flow proceeds to the operation 304; otherwise, the flow proceeds to the operation 305.

In the operation 303, the currently connected display channel of the TV set includes a general TV channel (over which an analog signal is received), a cabled TV channel, an IPTV network TV channel, an all-game channel, a DVD player channel, etc.

In the operation 304, the control chip transmits a logic signal command to a change-over switch using a logic control signal through a logic switch control unit to have the change-over switch switched onto USB ports of the TV set module to thereby connect the USB ports of the TV set module with external USB ports of the TV set, where the USB ports of the TV set module can be connected with a part or all of the external USB ports.

In the operation 304, if an operator clicks on and selects through a remote controller the general TV channel (over which an analog signal is received), then the currently connected display channel of the TV set is the TV channel.

In the operation 305, the control chip judges through an insertion signal detecting unit whether there is a set-top box inserted into the interface corresponding to the currently connected display channel; and if so, then the flow proceeds to the operation 306; otherwise, the flow proceeds to the operation 304.

In the operation 306, the control chip transmits a logic signal command to a change-over switch using a logic control signal through the logic switch control unit to have the change-over switch switched onto a USB signal of the set-top box.

In the operation 306, if the control chip judges through the insertion signal detecting unit that there is a set-top box module inserted at the interface location corresponding to the currently connected display channel, then the set-top box module is determined as an internal module for which a USB needs to be accessed. At this time the control chip transmits the logic signal command to the change-over switch through the logic switch control unit to have the switch switched onto the internal USB ports of the determined set-top box module to thereby connect the internal USB ports of the determined set-top box module with the corresponding external USB ports.

If there are a plurality of set-top boxes, then the control chip judges through the insertion signal detection unit whether there is a set-top box module inserted at the interface location corresponding to the currently connected display channel. That is, the operator selects the alternative cabled TV channel, IPTV network TV channel, all-game channel or DVD player channel instead of the general TV channel for watching by clicking on the channel through the remote controller, then it can be judged from a changing display picture of the TV set whether there is a corresponding signal connected for the cabled TV channel, the IPTV network TV channel, the all-game channel or the DVD player channel.

According to the embodiment of the disclosure, when the internal USB ports of the set-top box module are connected with all of the external USB ports, all of the external USB ports can be identified and a relevant process may be performed, so that the problem of a too large number of USB ports can be addressed.

As can be apparent from the description above, the external USB ports of the TV set can be connected with either the internal USB ports of the TV set module or the internal USB ports of the set-top box module to thereby lower the number of external USB ports of the TV set and save a space of the master board of the TV set.

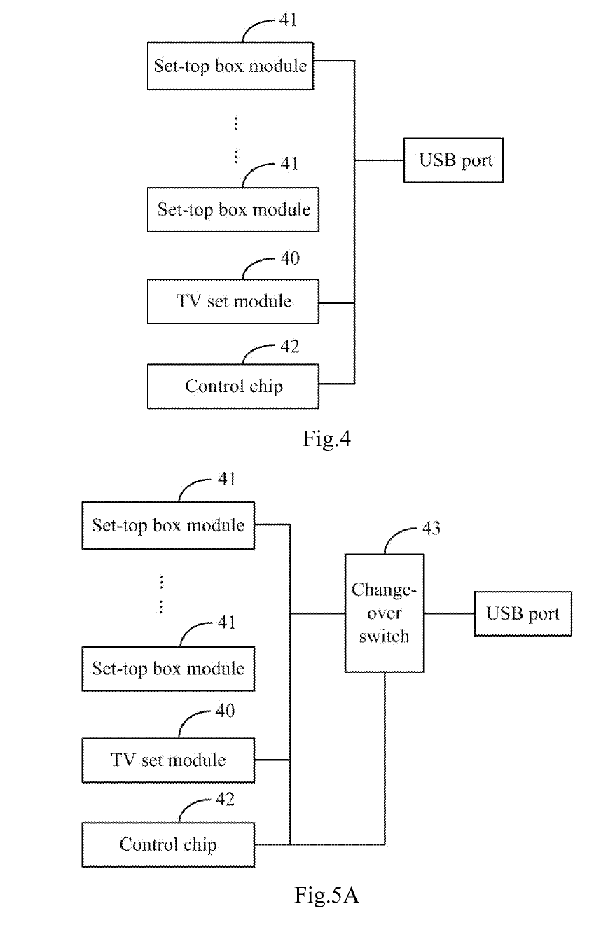

Another embodiment of the disclosure provides a device for connecting a USB port, and as illustrated in FIG. 4, the device for connecting a USB port includes a TV set module 40, at least one set-top box module 41 and a control chip 42.

The control chip 42 is configured to check for an internal module for which a USB needs to be accessed; and if the internal module for which the USB needs to be accessed is the TV set module, to connect internal USB ports of the TV set module with external USB ports of a display device; and if the internal module for which the USB needs to be accessed is the set-top box module, to connect internal USB ports of the set-top box module with the external USB ports of the display device.

Where the external USB ports connected with the internal USB ports of the TV set module are the same as a part or all of the external USB ports connected with the internal USB ports of the set-top box module.

The control chip includes an insertion signal detecting unit and a logic switch control unit, where the insertion signal detecting unit can identify an interface location corresponding to the set-top box module by detecting an insertion signal of the set-top box module.

The set-top box module 41 can include various set-top boxes connected in a wired manner or wirelessly with a radio and TV network, a local area network and a wide area network, and also modules with game, entertainment, security and other dedicated functions. In addition to the original traditional functions, the set-top box module can be further provided with internal USB ports via which the set-top box module can be connected with the external USB ports. The set-top box connected with the TV set system provides the TV set system with the insertion signal.

The TV set module 40 is provided with internal USB ports via which the TV set module can be connected with the external USB ports.

In an implementation, the control chip 42 determines that the internal module for which the USB needs to be accessed is the TV set module, when a currently connected display channel is a TV channel; and that the internal module for which the USB needs to be accessed is the set-top box module, when the currently connected display channel is not the TV channel.

In an implementation, there may be a number of display channels of the display device, e.g., the display channel of the display device can be a general TV channel (over which an analog signal is received), a wired TV channel, an IPTV network channel, an all-game function channel, a DVD player channel, etc.

If there are a plurality of set-top box modules in the display device according to the embodiment of the disclosure and it is determined that the internal USB ports of the set-top box modules need to be connected with the external USB ports of the display device, then the control chip 42 further determines the set-top box module corresponding to the currently connected display channel according to a correspondence relationship between the display channel and the set-top box module, and connects the internal USB port of the determined set-top box module with the external USB port.

In an implementation, if there are a plurality of set-top box modules which can be a wired TV set-top box, an IPTV network TV set-top box, an all-game set-top box, etc., then the display device judges through an insertion signal detection unit whether there is a corresponding signal connected for (the module inserted on) the cabled TV channel, the IPTV network TV channel or the all-game channel at the interface location corresponding to the currently connected display channel.

Optionally the control chip 42 can connect the internal USB ports of the TV set module with the external USB ports of the display device or connect the internal USB ports of the set-top box module with the external USB ports of the display device through one change-over switch.

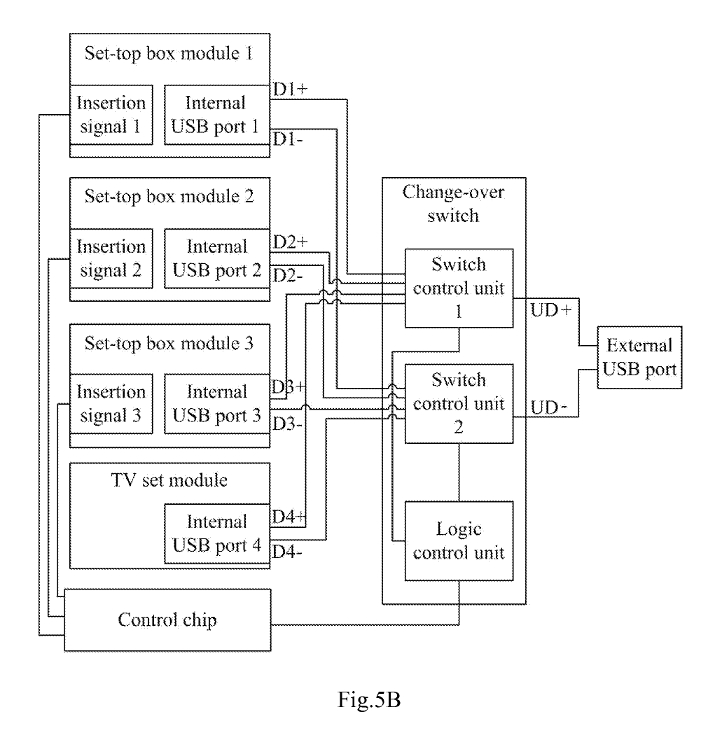

As illustrated in FIG. 5A, the display device according to the embodiment of the disclosure can further include a change-over switch 43.

The change-over switch is configured to be controlled by the control chip to connect the TV set module or the set-top box module with the external USB ports.

Optionally the control chip 42 is configured:

If the internal module for which the USB needs to be accessed is the TV set module, to control the change-over switch to connect the TV set module with the external USB ports.

If the internal module for which the USB needs to be accessed is the set-top box module, to control the change-over switch to connect the set-top box module with the external USB ports.

The solution of the disclosure will be described below taking a display device including three set-top box modules and one external USB port as an example.

As illustrated in FIG. 5B which is a flow chart of a device according to an embodiment of the disclosure, all of internal USB ports 1 to 3 of the set-top box modules, and an internal USB port 4 of a TV set module are connected with a change-over switch.

Particularly anode signals D1+ to D3+ of the internal USB ports 1 to 3 of the set-top box modules are connected respectively with a switch control unit 1, and cathode signals D1− to D3− of the internal USB ports 1 to 3 of the set-top box modules are connected respectively with a switch control unit 2; and an anode signal D4+ of the internal USB port 4 of the TV set module is connected with the switch control unit 1, and a cathode signal D4− of the internal USB port 4 of the TV set module is connected with the switch control unit 2.

The control chip 42 is connected with a logic control unit of the change-over switch.

In an implementation, the control chip transmits a logic signal command to the logic control unit in the change-over switch; and the logic control unit controls the switch control unit 1 to be connected with one of D1+ to D4+, and the switch control unit 2 to be connected with one of D1− to D4−, in response to the logic signal command.

If D4+ is connected with the switch control unit 1, and the switch control unit 2 is connected with D4−, then the internal USB port 4 of the TV set module is connected with the external USB port.

For example, if the set-top box module 1 is to be connected currently, then the control chip transmits a logic signal command to the logic control unit in the change-over switch; and the logic control unit controls the switch control unit 1 to be connected with D1+, and the switch control unit 2 to be connected with D1−, in response to the logic signal command to thereby connect the internal USB port 1 of the set-top box 1 with the external USB port.

It shall be noted that FIG. 5B illustrate only one implementation in which the internal USB port is connected with the external USB port through the change-over switch, and other implementations in which two USB ports are connected can be applicable to the embodiment of the disclosure.

In an implementation, one display device can be provided with one or more external USB ports. If there are a plurality of external USB ports, then a part of the plurality of external USB ports can be external USB ports shared by the set-top box module and the TV set module, and the remaining external USB ports are external USB ports specific to the set-top box module and the TV set module. For example, there are four external USB ports including two shared external USB ports, one external USB port specific to the TV set module and one external USB port specific to the set-top box module.

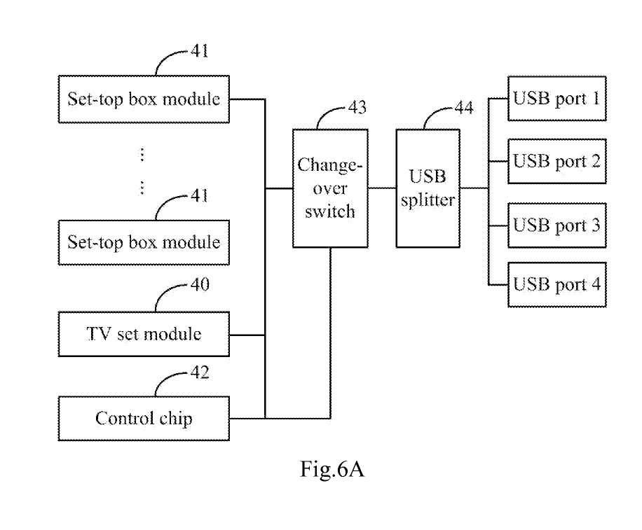

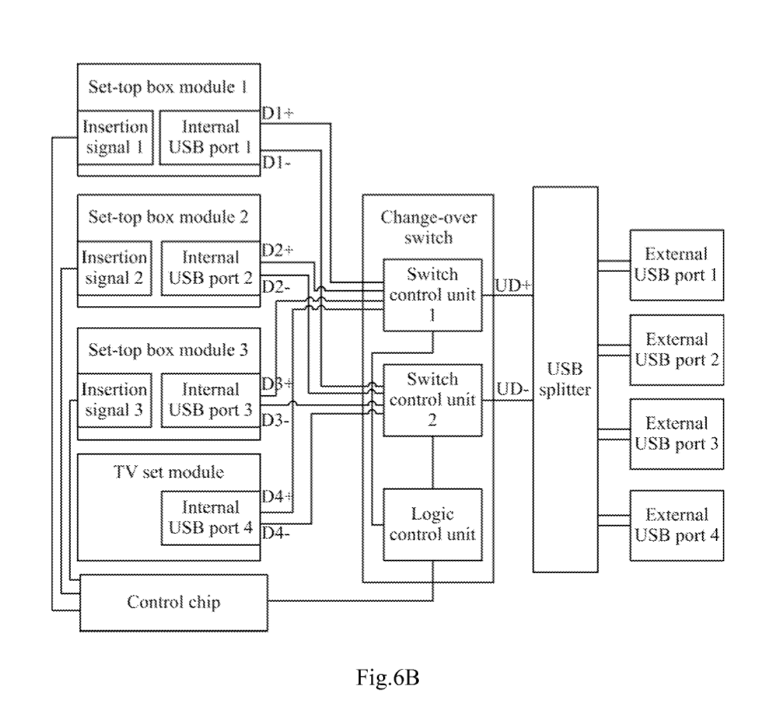

Optionally all of the external USB ports are shared external USB ports. As illustrated in FIG. 6A, the display device according to the embodiment of the disclosure can further include a USB splitter 44.

The USB splitter 44 is configured to connect the change-over switch with each external USB port.

The solution of the disclosure will be described below taking a display device including three set-top box modules, one external USB splitter and a plurality of external USB ports as an example.

As illustrated in FIG. 6B which is a flow chart of a device according to another embodiment of the disclosure, all of internal USB ports 1 to 3 of set-top box modules, and an internal USB port 4 of a TV set module are connected with a change-over switch.

Particularly anode signals D1+ to D3+ of the internal USB ports 1 to 3 of the set-top box modules are connected respectively with a switch control unit 1, and cathode signals D1− to D3− of the internal USB ports 1 to 3 of the set-top box modules are connected respectively with a switch control unit 2; and an anode signal D4+ of the internal USB port 4 of the TV set module is connected with the switch control unit 1, and a cathode signal D4− of the internal USB port 4 of the TV set module is connected with the switch control unit 2.

The control chip 62 is connected with a logic control unit of the change-over switch.

In an implementation, the control chip transmits a logic signal command to the logic control unit in the change-over switch; and the logic control unit controls the switch control unit 1 to be connected with one of D1+ to D4+, and the switch control unit 2 to be connected with one of D1− to D4−, in response to the logic signal command.

If D4+ is connected with the switch control unit 1, and the switch control unit 2 is connected with D4−, then the change-over switch connects a set of output USB signals UD+ and UD− into the USB splitter connected with a plurality of external USB ports to thereby connect the internal USB port 4 of the TV set module with the external USB port.

For example, if the set-top box module 1 is to be connected currently, then the control chip transmits a logic signal command to the logic control unit in the change-over switch; and the logic control unit controls the switch control unit 1 to be connected with D1+, and the switch control unit 2 to be connected with D1−, in response to the logic signal command. The change-over switch connects a set of output USB signals UD+ and UD− into the USB splitter to thereby connect the internal USB port 1 of the set-top box 1 with the external USB port.

In an implementation, the USB splitter can be connected with one or more external USB ports. If there are a plurality of external USB ports, then a part of the plurality of external USB ports can be external USB ports shared by the set-top box module and the TV set module, and the remaining external USB ports are external USB ports specific to the set-top box module and the TV set module. For example, there are four external USB ports including two shared external USB ports, one external USB port specific to the TV set module and one external USB port specific to the set-top box module.

In another embodiment of the disclosure, there is disclosed a method for transmitting data, and this method is applicable to a display component including a display device and a plurality of function modules, where each of the plurality of the function modules is connected with the display device via a data transmission interface, and the display device includes a data transmission port for connection with an external device. In an embodiment of the disclosure, the display device can be a device including a display screen and various ports, e.g., a display of a computer, or in another embodiment of the disclosure, the display device can also be provided with a function of decoding audio and video, e.g., a general TV set. The function module can be a module with a set-top box function or a module with a function of decoding audio and video, and in general, it can be a module with any function of transmitting data with the external device.

Where the connection between the display device and the function module is an internal connection of the display component, and a data transmission port of the display device is configured for connection with the external device, e.g., an external USB device, an external HDMI device, etc.

The method includes:

A function module for which data needs to be transmitted with the external device is determined. In a particular implementation of this operation, any indicator or characterization can be provided to indicate that the function module further needs to transmit data with the external device. For example, a user can confirm with an input device that the function module needs to read from/write to the external device, or this can be identified and confirmed automatically under a preset condition.

The data transmission interface, via which the function module for which data needs to be transmitted and the display device are connected, is enabled by a switch selection element. In an embodiment of the disclosure, reference can be made to the description in the embodiments above of the disclosure for the switch selection element itself, the connection relationships between the switch selection element, the function module and the data transmission interface of the display device, and their schematic functions. Particularly the switch selection element can be embodied as the combination of the functions of the change-over switch and the control chip, and the function module can be the TV set module or the set-top box module.

A connection pathway between the function module for which data needs to be transmitted, and the data transmission port of the display device is set up. After the connection between the function module and the data transmission interface of the display device is selected in the operation above, since there is a connection between the data transmission interface and the data transmission port of the display device, it can be considered at this time that there is a connection path between the function module and the data transmission port of the display device.

Data is transmitted over the connection pathway set up in the operation above.

Reference can be made to the description in any one of the embodiments above of the disclosure for the disclosure of this embodiment.

As can be apparent from the description of the flow charts and the solutions above, the external USB ports of the TV set can be connected with either the internal USB ports of the TV set module or the internal USB ports of the set-top box module to thereby lower the number of external USB ports of the TV set and save a space of the master board of the TV set.

It shall be appreciated that the device for connecting a USB port has been merely divided logically into the modules dependent upon the functions performed by the device, and in a real application, the units above can be combined or divided. Moreover the functions performed by the device for connecting a USB port according to this embodiment correspond respectively to the functions in the method for connecting a USB port according to the embodiments above of the disclosure, and a particular processing flow performed by the device has been described in details in the embodiments above of the disclosure, so a repeated description thereof will be omitted here.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for connecting a Universal Serial Bus, USB, port, the method comprising:
checking, by a display device, for an internal module for which a USB needs to be accessed; and
if the internal module for which the USB needs to be accessed is a TV set module, then connecting internal USB ports of the TV set module with external USB ports of the display device, and
if the internal module for which the USB needs to be accessed is a set-top box module, then connecting internal USB ports of the set-top box module with the external USB ports of the display device;
wherein the external USB ports connected with the internal USB ports of the TV set module are the same as a part or all of the external USB ports connected with the internal USB ports of the set-top box module.

2. The method according to claim 1, wherein checking, by the display device, for an internal module for which the USB needs to be accessed comprises:
checking for an internal module for which the USB needs to be accessed, dependent upon a currently connected display channel.

3. The method according to claim 2, wherein checking for an internal module for which the USB needs to be accessed, dependent upon the currently connected display channel comprises:
determining, by the display device, that the internal module for which the USB needs to be accessed is the TV set module when the currently connected display channel is a TV channel; and
determining, by the display device, that the internal module for which the USB needs to be accessed is the set-top box module when the currently connected display channel is not a TV channel.

4. The method according to claim 3, wherein connecting, by the display device, the internal USB ports of the set-top box module with the external USB ports of the display device comprises:
determining, by the display device, the set-top box module corresponding to the currently connected display channel according to a correspondence relationship between the display channel and the set-top box module; and
connecting, by the display device, the internal USB port of the determined set-top box module with the external USB port.

5. The method according to claim 1, wherein connecting, by the display device, the internal USB ports of the TV set module with the external USB ports of the display device comprises:
if there are a plurality of external USB ports, then connecting, by the display device, the internal USB ports of the TV set module respectively with each external USB port; and
connecting, by the display device, the internal USB ports of the set-top box module with the external USB ports of the display device comprises:
if there are a plurality of external USB ports, then connecting, by the display device, the internal USB ports of the set-top box module respectively with each external USB port.

6. A display device for connecting a Universal Serial Bus, USB, port, comprising a TV set module and a set-top box module, the device further comprising:
a control chip configured to check for an internal module for which a USB needs to be accessed, after the display device is powered on; and if the internal module for which the USB needs to be accessed is a TV set module, to connect internal USB ports of the TV set module with external USB ports of the display device; and if the internal module for which the USB needs to be accessed is a set-top box module, to connect internal USB ports of the set-top box module with the external USB ports of the display device;
wherein the external USB ports connected with the internal USB ports of the TV set module are the same as a part or all of the external USB ports connected with the internal USB ports of the set-top box module.

7. The display device according to claim 6, wherein the control chip is configured:
to check for an internal module for which the USB needs to be accessed, dependent upon a currently connected display channel.

8. The display device according to claim 7, wherein the control chip is configured:
to determine that the internal module for which the USB needs to be accessed is the TV set module when the currently connected display channel is a TV channel; and
to determine that the internal module for which the USB needs to be accessed is the set-top box module when the currently connected display channel is not a TV channel.

9. The display device according to claim 8, wherein the control chip is configured:
to determine the set-top box module corresponding to the currently connected display channel according to a correspondence relationship between the display channel and the set-top box module; and to connect the internal USB port of the determined set-top box module with the external USB port.

10. The display device according to claim 6, wherein the display device further comprises:
a change-over switch configured to be controlled by the control chip to connect the TV set module or the set-top box module with the external USB ports; and
the control chip is configured:
if the internal module for which the USB needs to be accessed is the TV set module, to control the change-over switch to connect the TV set module with the external USB ports, and
if the internal module for which the USB needs to be accessed is the set-top box module, to control the change-over switch to connect the set-top box module with the external USB ports.

11. The display device according to claim 10, wherein the display device is provided with a plurality of external USB ports; and
the display device further comprises:
a USB splitter configured to connect the change-over switch with each external USB port.

12. A method for transmitting data, the method being applicable to a display component comprising a display device and a plurality of function modules, wherein each of the plurality of the function modules is connected with the display device via a data transmission interface, and the display device comprises a data transmission port for connection with an external device, and the method comprises:
determining a function module for which data needs to be transmitted with the external device;
enabling, by a switch selection element, the data transmission interface via which the function module for which data needs to be transmitted and the display device are connected;
setting up a connection pathway between the function module for which data needs to be transmitted, and a data transmission port of the display device; and
transmitting data over the set-up connection pathway.
